(19) United States
(12) Patent Application Publication
(10) Pub. No.: US 2004/0100678 A1
(43) Pub. Date: May 27, 2004

(54) Method for finesse compensation in a fabry-perot device and a fabry-perot device with high finesse

(76) Inventors: Sean Chang, Taoyuan (TW); Ching-yang Juan, Taoyuan (TW)

Correspondence Address: MARTINE & PENILLA, LLP, 710 LAKEWAY DRIVE, SUITE 170, SUNNYVALE, CA, 94085, US

(21) Appl. No.: 10/339,881

(22) Filed: Jan. 9, 2003

(30) Foreign Application Priority Data
Nov. 21, 2002 (TW) 91134032

(51) Int. Cl. G02B 26/00

(52) U.S. Cl. 359/290

(57) ABSTRACT

The present invention discloses a method for finesse compensation in a Fabry-Perot device having a first reflector and a second reflector that are parallel. The method includes the following steps. Orthogonally arranging a plurality of first actuation elements at the periphery of the first reflector; electrically connecting the plurality of first actuating elements to a plurality of independent driving voltages; and controlling the plurality of independent driving voltages to drive the plurality of first actuation elements and then actuate the first reflector to tilt relative to the second reflector in two rotation degrees of freedom.

### BACKGROUND OF THE INVENTION

(a) Field of the Invention

The invention relates to a method for finesse compensation in a Fabry-Perot device and a Fabry-Perot device with high finesse. More particularly, it relates to a method for finesse compensation in a Fabry-Perot device by using independent driving voltages control to regulate a tilt of a reflector thereof, and a Fabry-Perot device realizing that method.

(b) Description of the Related Art

During the recent years, various optical application techniques have been flourished on the ground of the advantageous characteristics of light waves, such as reflection, refraction, interference, fast transmission rate, etc. The optical communication is a good example. Since the data transmission is implemented through the travel of light waves in optical communication, there is no doubt that the transmission efficiency depends largely on the characteristics of light waves during data transmission. In other words, for the purpose that an expected transmission efficiency can be achieved, the intrinsic restrictions of light waves must be overcome for all these various active or passive optical devices being used in the current optical communication network.

To satisfy such requirement, the existing optical devices are fabricated by submicron, or even nanometer manufacturing techniques like semiconductor and micro-electro-mechanical systems (MEMS) manufacturing techniques. For instance, a micro Fabry-Perot device is developed by semiconductor techniques and surface micro machining in the MEMS techniques.

FIG. 1 is a perspective schematic view showing a micro Fabry-Perot device fabricated by semiconductor and MEMS techniques according to the prior art. Referring to FIG. 1, a micro Fabry-Perot device 10 has two parallel reflectors 11 and 12 that are coated with optical films. Herein, the reflector 11 is formed on a glass substrate 13 by semiconductor manufacturing techniques and the reflector 12 is formed on a silicon substrate 14 by MEMS manufacturing techniques. A distance D between two reflectors 11 and 12 is called the optical thickness. The reflector 12 is a moving reflector with a movable distance d, and d<<D. In application, the micro Fabry-Perot device is generally used as a filtering element, and the movable distance d is tuned to obtain an expected wavelength spectrum for elevating the bit rate of data transmission. For the reason that wavelength distribution of an outgoing light passed through the Fabry-Perot device is approximately a Gaussian distribution, a designer consequently takes the full-width-at-half-maximum (FWHM) value as a prime design parameter. The optical properties of a Fabry-Perot device are defined below.

FSR (free spectrum ratio)=λ²/2nD, where λ is the center wavelength, n is the optical index, and D is the distance between two parallel reflectors.

F (finesse)=π√R/(1−R), where R is the reflectance of the two parallel reflectors.

FWHM=FSR/F.

FIG. 2 is a schematic view showing the spectrum of the light waves passed through a Fabry-Perot device, wherein FSR represents the distance between the center wavelengths of two waves, FWHM represents the bandwidth when the transmittance is 50%, and the finesse F represents the ratio of FSR and FWHM. According to optical fiber communication ITU 100 GHz specifications, the spectrum of the outgoing light must satisfy the condition that FWHM is 0.37 nm and the free spectrum ratio FSR is at least 40 nm, in order that the particular wavelength λ ᵢ of the outgoing light passed through the aforesaid Fabry-Perot 10 equals a center wavelength λ of the C band within the wavelength range 1525 nm˜1565 nm, that is, 1550 nm. For example, to obtain a spectrum with an FWHM value of 0.37 nm and an FSR of 50 nm, the finesse F must be 135. Therefore, it is essential that a Fabry-Perot device own a high finesse in order that multi-channel and narrow-spectrum FWHM can be achieved in optical communication applications.

For a Fabry-Perot device, however, the finesse is affected by some factors in which the reflectance R and the tilt of reflectors are the most important. To be more explicit, 1/F 1/F_{R}+1/F_{θ}, wherein F_{R} is the contribution value of the reflectance to the finesse, and F_{θ} is the contribution value of the tilt to the finesse. As a result, the insufficient reflectance and inappropriate tilt of two reflectors made of optical films may be caused due to the difficulties in controlling the film finesse, thereby causing an error between the actual FWHM and the expect value.

Therefore, the tilt of the reflectors needs to be adjusted for compensation besides increasing the reflectance of the two reflectors to ensure that the Fabry-Perot device is able to maintain a modulated accuracy of each incident light under a high finesse requirement. For instance, when the reflectance of the coated optical film is 99.5%, it is calculated that F_{R} equals 625 from the above equation F_{R}=π√R/(1−R). However, this F_{R} value is very different from the expected value 135, meaning that the tilt of the reflectors has to be adjusted. Under such circumstances, one of the reflectors needs to be tilted for compensation in order to reach the expected finesse. In this example, when the contribution value of the tilt to the finesse F_{θ} is calculated, the value of tilt can be calculated out according to the equation F_{θ}=λ/2Dθ (where λ is the wavelength of the light waves, D is the diameter of the light beams, and θ is the tilt), which equals 3.8×10⁻⁴ degrees.

Yet, since the above Fabry-Perot device fabricated by semiconductor and MEMS manufacturing techniques is considerably small in volume, the degree of the tilt to be compensated is therefore considerably small. For this reason, the tilt compensation in the Fabry-Perot device and the designer's requirement with respect to FWHM can not be satisfied by employing common machinery so far.

### SUMMARY OF THE INVENTION

To solve the above issues, an object of the invention is to provide a method for finesse compensation in a Fabry-Perot device.

Second object of the invention is to provide a method for adjusting the reflector tilt in a Fabry-Perot device.

Third object of the invention is to provide a Fabry-Perot device with high finesse for realizing an expected FWHM and conforming to the application requirements of optical fiber communications.

The method for finesse compensation in a Fabry-Perot device in accordance with an aspect of the invention includes the following steps. Arranging a plurality of actuating elements orthogonally at the periphery of a first reflector, electrically connecting the plurality of first actuating elements to a plurality of independent driving voltages, and controlling the plurality of independent driving voltages to drive the plurality of first actuating elements and then actuate the first reflector to tilt relative to the second reflector in two rotation degrees of freedom. In an embodiment, the first actuating elements are provided with a plurality of combs, and the first reflector is formed on a silicon substrate.

Herein, the method for finesse compensation in a Fabry-Perot device in accordance with one aspect of the invention may further includes the following steps. Orthogonally arranging a plurality of second actuating elements at the periphery of a second reflector, electrically connecting the plurality of second actuating elements to an independent driving voltage, and controlling the independent driving voltage to drive the plurality of second actuating elements in order to actuate the second reflector to move relative to the first reflector a distance in parallel. In the embodiment, the second actuating elements are provided with a plurality of combs and the second reflector is formed on a silicon substrate.

Alternatively, the finesse compensation in a Fabry-Perot device in accordance with one aspect of the invention may further includes the following steps. Orthogonally arranging a plurality of second actuating elements at the periphery of a first reflector, electrically connecting the plurality of second actuating elements to an independent driving voltage, and controlling the independent driving voltage to drive the plurality of second actuating elements in order to actuate the first reflector to move relative to the second reflector a distance in parallel. In the embodiment, the second actuating elements are provided with a plurality of combs, and the second reflector is formed on a silicon substrate.

The Fabry-Perot device with high finesse in accordance with an aspect of the invention includes a first reflector, a second reflector, and four first driving voltages. The second reflector consists of a plane having a plurality of combs at the periphery and four actuating pads orthogonally arranged at each peripheral side of the plane, respectively. Herein, the neighboring sides of the periphery are perpendicular to one another. The plurality of combs which provided on the actuating pads are alternately arranged with the combs at the periphery of the plane. The four first driving voltages are electrically connected to the actuating pads of the second reflector, respectively, in order to drive the combs of the actuating pads and actuate the plane of the second reflector to tilt in two rotation degrees of freedom.

The Fabry-Perot device with high finesse in accordance with another aspect of the invention includes a first reflector and a second reflector. Herein, the second reflector is parallel to the first reflector. The second reflector consists of a plane having a plurality of first combs formed on the periphery whose neighboring sides are perpendicular to one another, and four actuating pads orthogonally arranged at the peripheral sides of the plane. Each actuating pad is provided with a first part actuating pad and a second part actuating pad. The first part actuating pad and the second actuating pad are further provided with a plurality of combs, respectively, and the combs of the first actuating pad and the second actuating pad are alternately arranged with the combs at the peripheral sides of the plane. Also included in the Fabry-Perot device with high finesse in accordance with another aspect of the invention are four first driving voltages, which are electrically connected to the first part actuating pads of respective actuating pads, for driving the combs of the first part actuating pad and actuating the plane to tilt in two rotation degrees of freedom.

The Fabry-Perot device with high finesse in accordance with another aspect of the invention includes a first reflector and a second reflector paralleled to the first reflector. The second reflector consists of a plane with a plurality of first combs and a plurality of second combs at the periphery, a plurality of first actuating pads orthogonally arranged at the peripheral sides of the plane with combs that are alternately arranged with the first combs, and a plurality of second actuating pads orthogonally arranged at the periphery of the plane with combs that are alternately arranged with the second combs. Also included in the Fabry-Perot device with high finesse in accordance with another aspect of the invention is a plurality of first independent driving voltages. They are electrically connected to the first actuating pads, respectively, in order to drive the combs of the first actuating pads and then to tilt the plane in two rotation degrees of freedom.

The advantages of the invention are that the accuracy of the displacement and tilt of the reflectors can be ensured and the smoothness of the plane can be maintained to avoid the plane from bending during the control process, for the reason that the two reflectors of the Fabry-Perot device are arranged as an orthogonal comb structure. In one of the embodiments, silicon wafer having better heat-resistance than glass is adopted as the material for the reflectors, thereby reducing thermal stress issues. Moreover, each of the aforesaid independent voltages controls only one degree of freedom, therefore the control of the aforesaid independent voltages may be proceeded at the same time without interfering one another.

### BRIEF DESCRIPTION OF THE DRAWINGS

FIG. 1 is a schematic view showing a micro Fabry-Perot device fabricated by semiconductor and MEMS manufacturing techniques according to the prior art.

FIG. 2 is schematic view showing the spectrum characteristics of a light wave, wherein the upper horizontal axis represents the band serial number, the lower horizontal axis represents the wavelength, and the left vertical axis represents the transmittance in percentage (%).

FIG. 3A is a top view showing a reflector in the first embodiment of the invention.

FIG. 3B is a top view showing another reflector in the first embodiment of the invention.

FIG. 4 is a top view showing a moving reflector in the second embodiment of the invention.

FIG. 5 is a top view showing a moving reflector in the third embodiment of the invention.

FIG. 6 is a sectional schematic view along the line A-A in FIG. 3 illustrating the principle of tilting a reflector by actuating combs on the reflector.

FIG. 7 shows a diagram illustrating the relationship between the magnitude of input voltages on the combs and the displacement of combs on a moving reflector.

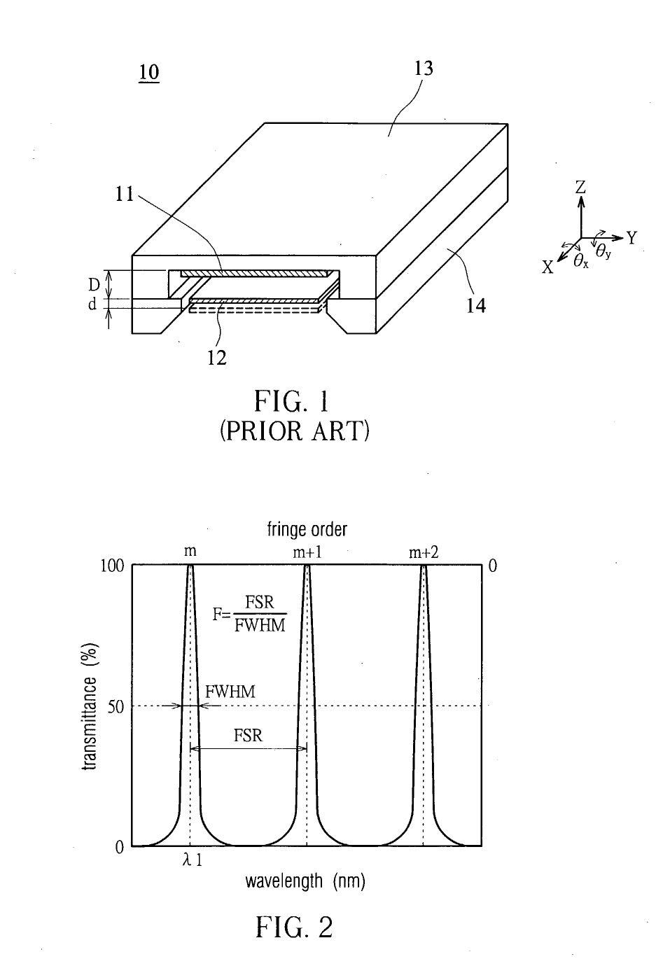

### DESCRIPTION OF THE PREFERRED EMBODIMENTS

The invention proposes a method that controls actuating elements through independent voltages for tuning the tilt of one reflector in a Fabry-Perot device. Thereby, the Fabry-Perot device has high finesse and allows that the FWHM of a light wave distribution passed through the Fabry-Perot device has an expected value. In addition, the method of controlling actuating elements through independent voltages may be further employed for tuning a distance between two reflectors of a Fabry-Perot device in order to rectify the waveform of a light wave distribution passed through the Fabry-Perot device.

First Embodiment

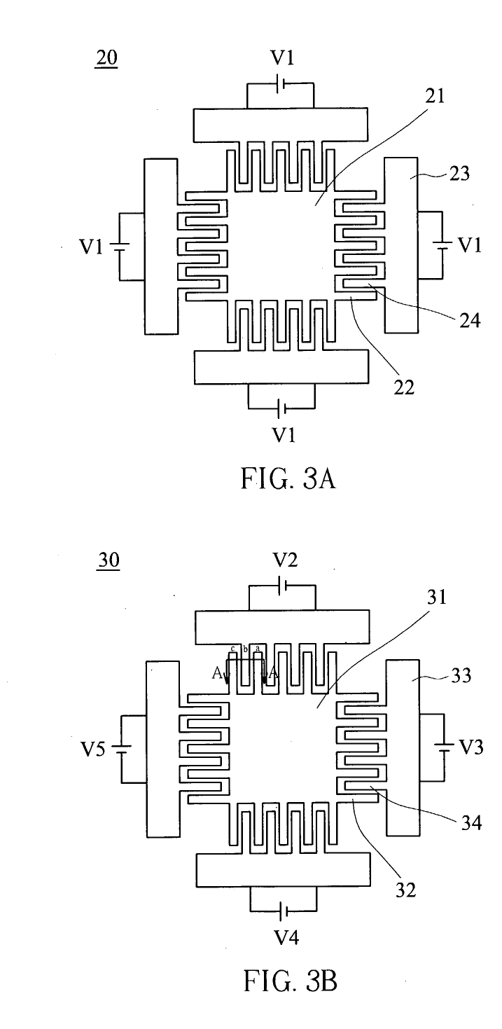

The method for finesse compensation in a Fabry-Perot device includes the following steps. Forming two parallel reflectors 20 and 30 from two silicon wafers, arranging the reflector 20 as an orthogonal comb structure having a top view as shown in FIG. 3A, arranging the other reflector 30 as another orthogonal comb structure having a top view as shown in FIG. 3B, controlling an independent voltage to move the reflector 20 relative to the reflector 30 and then to tune an optical thickness between the two reflectors, and controlling four independent voltages to tilt the reflector 30 relative to the reflector 20 so as to tune a tilt of the reflector 30.

Referring to FIG. 3A, the orthogonal comb structure of the reflector 20 includes a plane 21 that is provided with five strip-like combs 22 on each peripheral side, and four actuating pads 23 formed at each peripheral side of the plane 21. Especially, each actuating pad 23 is provided with four strip-like combs 24 alternately arranged with the combs 22, and each actuating pads 24 formed at the four peripheral sides of the plane 21 are electrically connected to an independent voltage V1.

Herein, all the combs 22 distributed on the plane 21 can be actuated such that the plane 21 moves in parallel to a direction perpendicular to the horizontal along the Z-direction as shown in FIG. 1 by controlling the magnitude and electric conductivity of the independent voltage V1. In other words, the reflector 20 can be tuned to a pre-determined position by moving it relative to the reflector 30. In addition, the moving precision of the plane 21 is further improved since that the four actuating pads 23 electrically connected to the independent voltage V1 are orthogonally formed at the four peripheral sides of the plane 21.

Referring to FIG. 3B, the orthogonal comb structure of another reflector 30 in the embodiment is identical to that of the reflector 20, and shall not be unnecessarily described. The difference is that four actuating pads 33 are electrically connected to four independent voltages V2, V3, V4 and V5, respectively.

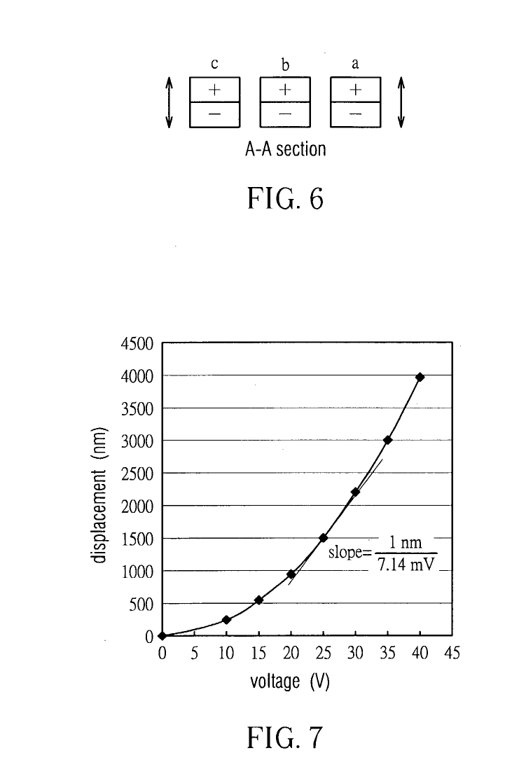

Herein, the combs 32 on a plane 31 are actuated by controlling the magnitude and electric conductivity of the independent voltages V2, V3, V4 and V5, such that the plane 31 tilts relative to a horizontal direction (or the xy plane shown in FIG. 1) and a tilt of the reflector 30 relative to the reflector 20 is tuned. Refer to FIG. 6 showing the cross-sectional schematic view along the line A-A in FIG. 3B for more detailed illustration. Referring to FIGS. 3B and 6, when a comb numbered b on the actuating pads 33 is applied with the voltage V2; positive and negative electric polarities are formed accordingly. Then, combs 32 numbered a and c on the plane 31 descend by a displacement as a result of the electric repulsion thereof. Based upon the principle, the independent voltages V2 and V4 may be adjusted to produce an angle change θ_{y} in the plane 31 as shown in FIG. 1, and the independent voltages V3 and V5 may also be adjusted to produce an angle change θₓ in the plane 31 as shown in FIG. 1.

In the embodiment, the five independent voltages V1, V2, V3, V4 and V5 respectively control one degree of freedom of the reflector (four rotation degrees of freedom and one transitional degree of freedom altogether), and therefore the five independent voltages control may be simultaneously carried out. Also as described above, the two reflectors of the Fabry-Perot device in the embodiment are arranged as an orthogonal structure, so that the precision of the displacement and tilt of the reflectors during the control process is ensured. Moreover, silicon wafers having better heat-resistance than glass materials are adopted as the material for the reflectors, and hence thermal stress issues are reduced.

It is to be noted that, the arrangement and structure of the reflectors 20 and 30 are not limited to orthogonal comb structures but may be other arrangements and structures, as long as the reflector 20 can be controlled by an independent voltage for displacement and the reflector 30 can be controlled by four independent voltages for tilt. Therefore, the numbers of the combs and actuating pads, and the shape of the plane described in the embodiment are merely illustrative but not restrictive.

Second Embodiment

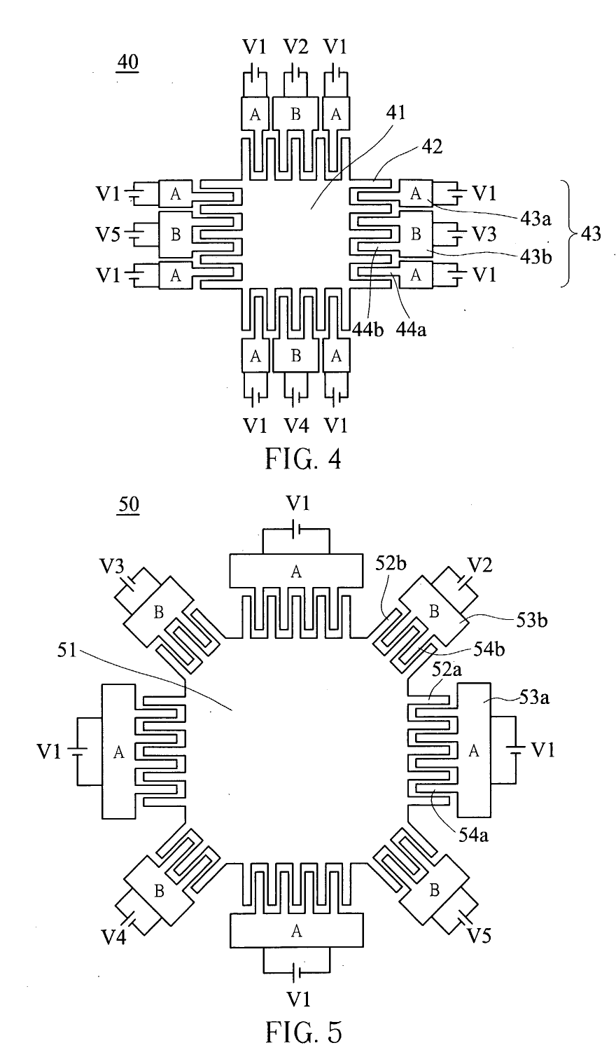

The method for finesse compensation in a Fabry-Perot device in the embodiment includes the following steps. Fabricating a fixed reflector (not shown) using a glass substrate and a moving reflector (refer to FIG. 4) using a silicon wafer, arranging the moving reflector as an orthogonal comb structure having a top view as shown in FIG. 4, controlling the moving reflector using an independent voltage to displace relative to the fixed reflector (not shown) and controlling the moving reflector using four independent voltages to tilt relative to the fixed reflector (not shown).

Referring to FIG. 4, the orthogonal comb structure of a moving reflector 40 in the embodiment has a plane 41 that is provided with five strip-like combs 42 at each peripheral side, and four actuating pads 43 formed at each peripheral side of the plane 41. Especially, each actuating pad 43 consists of two A actuating pads 43a at the ends and a B actuating pad 43b in the middle. Each A actuating pad 43a is provided with a strip-like comb 44a, each B actuating pad 43b is provided with two strip-like combs 44b, and the combs 44a and 44b are orthogonally arranged with the combs 42. Furthermore, all the A actuating pads 43a are electrically connected to an independent voltage V1, while each of the B actuating pads at the four peripheral sides is electrically connected to independent voltages V2, V3, V4 and V5, respectively.

Herein, the combs at the two ends of each peripheral side of the actuating plane 41 are actuated by controlling the magnitude and electric conductivity of the independent voltage V1, such that the plane 41 moves in a direction perpendicular to the horizontal plane, thereby tuning a displacement of the reflector 40 relative to the fixed reflector (not shown). In addition, the combs in the middle of each peripheral side of the plane 41 are respectively actuated by controlling the magnitude and electric conductivity of the independent voltages V2, V3, V4 and V5, so that the plane 41 can be rotated relative to the horizontal plane (or the XY plane shown in FIG. 1), thereby a tilt of the reflector 40 relative to the fixed reflector (not shown) is tuned.

In other words, the displacement and tilt of the plane 41 of the moving reflector 40 in the embodiment is simultaneously controlled through five independent voltages. Since the four actuating pads 43 electrically connected to the independent voltage V1 are orthogonally arranged at the four peripheral sides of the plane 41, the smoothness of the plane 41 during moving is accurately maintained to avoid the plane 41 from bending.

It is to be noted that, the structure arrangement of the moving reflector 40 are not limited to orthogonal comb structures but may be other arrangements and structures, as long as the moving reflector may be controlled by an independent voltage for displacement and four independent voltages for tilt. Therefore, the numbers of the combs and actuating pads, and the shape of the plane described in the embodiment are merely illustrative but not restrictive.

Third Embodiment

The method for finesse compensation in a Fabry-Perot device in the embodiment includes the following steps. Fabricating a fixed reflector (not shown) using a glass substrate and a moving reflector (refer to FIG. 5) using a silicon wafer, arranging the moving reflector as a truncated orthogonal comb structure having a top view as shown in FIG. 5, and controlling the moving reflector using an independent voltage to displace relative to the fixed reflector (not shown) while controlling the moving reflector using four independent voltages to tilt relative to the fixed reflector (not shown).

Referring to FIG. 5, the truncated orthogonal comb structure of a moving reflector 50 in the embodiment has a plane 51 with five strip-like combs 52a individually formed on each orthogonal peripheral side and three strip-like combs 52b individually formed on each truncated corner. Furthermore, four A actuating pads 53a are formed orthogonally at the four peripheral sides of the plane 51 and four B actuating pads 53b are formed orthogonally at the sides of the four truncated corners of the plane 51, respectively. Each A actuating pad 53a is provided with four strip-like combs 54a alternately arranged with the combs 52a, and each of the B actuating pads 53b is provided with two strip-like combs 54b alternately arranged with the combs 52a. Especially, all the actuating pads A at the four sides of the plane 51 are electrically connected to an independent voltage V1, whereas the actuating pads B at the sides of the four truncated corners are electrically connected to four independent voltages V2, V3, V4 and V5, respectively.

Herein, the combs 52a at the four sides on the actuating plane 51 can be actuated by controlling the magnitude and electric conductivity of the independent voltage V1, such that the plane 51 moves in a direction perpendicular to the horizontal plane, thereby tuning a displacement of the moving reflector 50 relative to a fixed reflector (not shown). In addition, the combs 52b at the four truncated corners of the actuating plane 51 can be respectively actuated by controlling the magnitude and electric conductivity of the independent voltages V2, V3, V4 and V5, such that the plane 51 can be tilt relative to the horizontal plane (or the XY plane shown in FIG. 1), thereby tuning a tilt of the moving reflector 50 relative to the fixed reflector (not shown).

In the embodiment, there are only four independent voltages be used for controlling the combs 52b at the four truncated corners of the plane 51 to attain the tilt adjustment since the tilt change of the moving reflector 50 is quite small. Furthermore, in the embodiment of the invention, since the combs 51a used to adjust the moving reflector 50 relative to the fixed reflector (not shown) are orthogonally arranged, the smoothness of the moving 50 reflector can be maintained such that the plane 51 is not bent during the moving process.

It is to be noted that, the structure arrangement of the moving reflector 50 are not limited to orthogonal comb types having truncated corners but may be others, as long as the displacement and tilt of the moving reflector may be respectively controlled by an independent voltage and four independent voltages. Therefore, the number of the combs and actuating pads, and the shape of the plane described in the embodiment are merely illustrative but not restrictive.

FIG. 7 shows a diagram of the relationship between the input voltage of the combs 34 and the displacement of the combs 32 of the plane. Referring to FIG. 7, the relationship between the voltage and the displacement is approximately linear. Consequently, as far as the invention is concerned, it can be calculated that the displacement needed for the combs 32 at the plane 31 is approximately 20 nm when the tilt to be compensated is 3.8×10⁻⁴ degrees, and this can be accomplished by applying a voltage of 142.8 mV to the combs 34.

It is to be noted that, in the various examples described above, the number of combs on the planes and actuating pads may be altered depending on the designer's needs. The section configuration of the combs may also be others besides rectangles. In addition, the magnitude and electric conductivity of the independent voltages may be adjusted for accommodating the desired designs accordingly to facilitate the tilt adjustment of the planes.

For summing up, the embodiments of the invention have been clearly described as above. However, it is to be understood for those who are skilled with the techniques that the described examples are only illustrative but not limitative. That is, variations and modifications made based upon the above elements shall be embraced within the invention without departing from the true spirit and scope of the invention. For example, the arrangements of independent voltages in the invention may be varied according to the shapes of planes and the arrangements of combs. Therefore, the invention is to be defined by the appended claims.

What is claimed is:

1. A method for finesse compensation in a Fabry-Perot device having a first reflector and a second reflector that are parallel, comprising the steps of:
orthogonally arranging a plurality of first actuating elements at the periphery of the first reflector;
electrically connecting the first actuating elements to a plurality of independent driving voltages; and
controlling the independent driving voltages to drive the first actuating elements, and then to actuate the first reflector to tilt relative to the second reflector in two rotation degrees of freedom.

2. The method for finesse compensation in a Fabry-Perot device described in claim 1, further comprising the steps of:
orthogonally arranging a plurality of second actuating elements at the periphery of the second reflector;
electrically connecting the second actuating elements to an independent driving voltage; and
controlling the independent driving voltage to drive the second actuating elements, and then to actuate the second reflector to move relative to the first reflector a distance in parallel.

3. The method for finesse compensation in a Fabry-Perot device described in claim 1, further comprising the steps of:
orthogonally arranging a plurality of second actuating elements at the periphery of the first reflector;
electrically connecting the second actuating elements to an independent driving voltage; and
controlling the independent driving voltage to drive the second actuating elements, and then to actuate the first reflector to move relative to the second reflector a distance in parallel.

4. The method for finesse compensation in a Fabry-Perot device described in claim 2, wherein the first reflector and the second reflector are formed on a silicon substrate.

5. The method for finesse compensation in a Fabry-Perot device described in claim 3, wherein the first reflector is formed on a silicon substrate and the second reflector is formed on a glass substrate.

6. The method for finesse compensation in a Fabry-Perot device described in claim 1, wherein the first actuating elements have a plurality of combs.

7. The method for finesse compensation in a Fabry-Perot device described in claim 2, wherein the second actuating elements have a plurality of combs.

8. A method for finesse compensation in a Fabry-Perot device having a first reflector and a second reflector that are parallel, comprising the steps of:
arranging the first reflector as an orthogonal comb-like structure having a plurality of first comb-like actuating elements at the periphery;
electrically connecting the first comb-like actuating elements to a plurality of first independent driving voltages; and
controlling the first independent driving voltages to drive the first comb-like actuating elements, and then to actuate the first reflector to tilt relative to the second reflector in two rotation degrees of freedom.

9. The method for finesse compensation in a Fabry-Perot device as described in claim 8, further comprising the steps of;
arranging the second reflector as an orthogonal comb-like structure having a plurality of second comb-like actuating elements at the periphery;
electrically connecting the second comb-like actuating elements to a second independent driving voltage; and
controlling the second independent driving voltage to drive the second comb-like actuating elements, and then to actuate the second reflector to move relative to the first reflector a distance in parallel.

10. The method for finesse compensation in a Fabry-Perot device described in claim 9, wherein the first reflector and the second reflector are formed on a silicon substrate.

11. The method for finesse compensation in a Fabry-Perot device as described in claim 8, further comprising the steps of:
arranging a plurality of second comb-like actuating elements at the periphery of the first reflector;
electrically connecting the second comb-like actuating elements to a second independent driving voltage; and
controlling the second independent driving voltage to drive the second comb-like actuating elements, and then to actuate the first reflector to move relative to the second reflector a distance in parallel.

12. The method for finesse compensation in a Fabry-Perot device as described in claim 11, wherein the first reflector is formed on a silicon substrate and the second reflector is formed on a glass substrate.

13. A Fabry-Perot device with high finesse comprising:
a first reflector;
a second reflector comprising:
a mirror having a plurality of combs at each peripheral side that are perpendicular to one another; and
four actuating pads orthogonally arranged at each peripheral side of the mirror, respectively, each of the actuating pads is provided with a plurality of combs which are alternately arranged with the combs at the peripheral side of the mirror; and
four first independent driving voltages electrically connected to the actuating pads of the second reflector, respectively, to drive the combs of each actuating pads and then to actuate the mirror of the second reflector to tilt in two rotation degrees of freedom.

14. The Fabry-Perot device with high finesse as described in claim 13, wherein the first reflector further comprises:
a mirror having a plurality of combs on each peripheral side that are perpendicular to one another; and
four actuating pads orthogonally arranged at each peripheral side of the mirror, respectively, and each of the actuating pads is provided with a plurality of combs alternately arranged with the combs at each peripheral side of the mirror.

15. The Fabry-Perot device with high finesse as described in claim 14, further comprising:
a second independent driving voltage electrically connected to the actuating pads of the first reflector to drive the combs of each actuating pads, and then to actuate the plane of the first reflector to move relative to the plane of the second reflector a distance in parallel.

16. The Fabry-Perot device with high finesse as described in claim 13, wherein the first reflector and the second reflector are formed on a silicon substrate.
